(19) United States
(12) Patent Application Publication
(10) Pub. No.: US 2023/0153084 A1
(43) Pub. Date: May 18, 2023

(54) SYSTEM AND METHOD FOR PROCESSING EVENTS

(71) Applicant: SymOps, Inc., Boston, MA (US)

(72) Inventors: Yasyf Zeid Mohamedali, Cambridge, MA (US); Jonathan Edmund Bass, San Francisco, CA (US); Adam Clinton Buggia, San Francisco, CA (US); Xiangquan Meng, San Francisco, CA (US)

(73) Assignee: SymOps, Inc., Boston, MA (US)

(21) Appl. No.: 17/526,547

(22) Filed: Nov. 15, 2021

(51) Int. Cl. G06F 8/36; G06F 8/30; G06F 40/186; G06F 8/41

(52) U.S. Cl. CPC G06F 8/36; G06F 8/313; G06F 40/186; G06F 8/433

(57) ABSTRACT

A platform is provided that enable users to create workflows for processing events of various types. In particular, users are provided templates for performing common cybersecurity and productivity operations that are able to be provisioned in real time. In some embodiments, these templates may process different type of events of various kinds and deploying them reduces the effort required for creating and maintaining new workflows.

### BACKGROUND

There are many methods for processing events in a computer-based distributed network. Workflows and other business logic are used to perform special processes in companies that use software for performing business processes within the company. Unfortunately, it is a difficult process to manually create such workflows and other business logic, as such programming necessitates skilled programming people with diverse security and infrastructure experience, many of whom are in short supply.

### SUMMARY

It is appreciated that it would be beneficial to provide a platform for programming common cybersecurity and productivity workflows as pieces of IT infrastructure that can be provisioned alongside other pieces of infrastructure using an infrastructure-as-code paradigm. More particularly, it is appreciated that many DevSecOps workflows in software companies, such as gating sensitive data or IT infrastructure behind access control schemes, follow an 80/20 paradigm where 80% of the effort is spent on implementing workflow primitives that are common among companies, while the remaining 20% of the effort is spent on implementing logics that are specific to the use case and system architecture of the company. Thus it is appreciated by the inventors that this paradigm creates a need for a workflow provisioning system that is generic enough to capture the commonalities across different companies' implementations, while also customizable enough to fit the exact needs of each company.

Specifically, in some embodiments, one or more event sources may be used to trigger the instantiation of workflows which perform certain actions. These event sources may be any type of entity that exists in the distributed network. Depending on the type of event source, a workflow element may be provided that processes a particular type of event. In some embodiments, these workflow elements may include templates that may be customized to process particular events. Such events, may be, for example, command line interface (CLI) input, message from messaging services such as Slack or MS Team, SMS messages, request from HTTP API endpoints, or any other type of event.

In some embodiments, common workflow primitives are provided in the form of templates, which are abstractions of the workflows that can be instantiated by an implementer in the form of flows. The templates, in some implementations, may be analogous to abstract classes in object-oriented programing, while the flows are analogous to fully defined and parameterized classes that inherit from the abstract templates. Events received from one or more systems are processed by a workflow component that is instantiated based on the type of event.

In some embodiments, the workflow elements may be combined to create a complex workflow. In some embodiments, workflow elements may be arranged in a hierarchy where one workflow can trigger another workflow. Further, in some implementations, different types of templates may be provided to perform various actions, such as, for example, an approval template that defines one or more access methods for accessing a resource of a particular type. In some embodiments, a resource in a company's system can be a sensitive database, a piece of the infrastructure that a user may request access via the system, or any other computing resource. Types of accesses that may be performed include reading, viewing, modifying, writing, execution, or other operation relating to the particular resource.

Other types of templates may be provided such as a risk assessment template. For instance, a risk assessment template may be provided that defines one or more workflows that are configured to identify an affected risk assessment datasheet based on a change in a customer's computing infrastructure. Also, a notification and review template may be provided. For example, a notification and review template may define one or more workflows that are configured to notify a user to take a certain action as part of a security-based workflow. Also, a data leak prevention template may be provided. In one example, a data leak prevention template may define one or more workflows that are configured to identify data accesses within the customer computing infrastructure. Other templates may be provided that define different actions within the computing infrastructure.

According to one aspect, a system is provided. The system comprises of a plurality of predefined workflow elements, each of the predefined workflow elements including a configurable template for accessing one or more resource types in a distributed computer system, providing for a user to selectively implement at least one of the plurality of predefined workflow elements, the at least one workflow element including a configured template, to access at least one resource of a selected resource type, and a processor configured to instantiate a runtime workflow element based on the configured template.

According to one embodiment, the configured template comprises at least one of a group comprising of a declaration of a workflow, resource information identifying the at least one resource, and logic for accessing the at least one resource. According to one embodiment, at least one resource is a computer-based entity, and wherein the processor provides access control functions to the at least one resource. According to one embodiment, at least one resource comprises a database, storage, a service, and a processing entity. According to one embodiment, the processor is configured to execute a strategy element associated with the runtime workflow element, the strategy element defining a process for accessing the at least one resource element.

According to one embodiment, the strategy element is a subcomponent of the runtime workflow element. According to one embodiment, the system further comprises a target element including information defining the at least one resource element to be accessed. According to one embodiment, the target element is a subcomponent of the runtime workflow element. According to one embodiment, the processor is configured to execute a handler element associated with the runtime workflow element, the handler element defining custom logic for executing the runtime workflow element.

According to one embodiment, the handler element includes a reducer element configured to receive an event and return a value. According to one embodiment, the handler element includes a hook element configured to alter a control flow by overriding a default behavior of the configurable template. According to one embodiment, the handler element includes an action element configured to subscribe to an event and cause an action to occur responsive to the subscribed event. According to one embodiment, the system is adapted to define a plurality of user role type for configuring how the processor creates and manages runtime workflow elements, the plurality of user role types comprising of a regular user type that uses a runtime workflow element to access the at least one resource, an integrator user type that provides integration elements for accessing a plurality of resources in an organization, and an implementer user type that is permitted to create and manage runtime workflow elements executed by the system.

According to one embodiment, the configurable template includes an approval template that defines one or more access methods for accessing the at least one resource. According to one embodiment, the system further comprises of a template interpretation engine configured to interpret a configuration definition.

According to one embodiment, the processor is adapted to receive and process a plurality of events from one or more event sources. According to one embodiment, the one or more event sources comprise at least one of a group comprising a message originated through a messaging platform, an API, a command line interface, a programmatic interface, an intersystem communication and a communication protocol message. According to one embodiment, the processor further comprises a queuer element configured to receive and queue the plurality of received events. According to one embodiment, the processor is adapted to process at least one of the plurality of received events from the queue. According to one embodiment, the processor is adapted to identify, responsive to the at least one of the plurality of received events, a workflow triggered by the event.

According to one embodiment, the processor is further adapted to instantiate a runtime workflow element and execute logic defined within the runtime workflow element. According to one embodiment, the logic defined within the runtime workflow element includes a handler element. According to one embodiment, the handler element includes a reducer element configured to receive an event and return a value. According to one embodiment, the handler element includes a hook element configured to alter a control flow by overriding a default behavior of the configurable template. According to one embodiment, the handler element includes an action element configured to subscribe to an event and cause an action to occur responsive to the subscribed event.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one embodiment are discussed herein with reference to the accompanying figures, which are not intended to be drawn to scale. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 shows a block diagram of a distributed computer system 100 capable of implementing various embodiments;

FIG. 2 shows a process for handling events according to some embodiments;

FIG. 3 shows a process for programming workflow elements according to some embodiments;

FIG. 4 shows a process for handling events and executing workflows according to some embodiments;

FIG. 5 shows a workflow execution engine that is configured to process various event types according to some embodiments;

FIG. 6 shows an example relational diagram of components that may be used to process events according to some embodiments;

FIG. 7A shows an example implementation of a workflow management infrastructure according to various embodiments;

FIG. 7B shows a more detailed architecture that may be used in a workflow management infrastructure according to various embodiments;

FIGS. 8A-8B show an example implementation for processing messages according to some embodiments;

FIG. 9 shows a more detailed example of a customer-handler role in accordance with some embodiments;

FIG. 10 shows another example of a customer-handler role according to various embodiments;

FIG. 11 shows a more detailed example of an execution role and customer-handler role according to some embodiments;

FIG. 12 shows a detailed example of a configuration that supports multi-tenancy;

FIG. 13 shows an example process for provisioning Sym flows according to some embodiments;

FIG. 14 shows an example integration used to authenticate an access by a user;

FIG. 15 shows an example architecture that handles one or more event types that request to access one or more resources according to some embodiments;

FIG. 16 shows an example flow used for just-in-time SSH access according to some embodiments;

FIG. 17 shows an example flow that adds an additional layer of security according to some embodiments;

FIG. 18 shows an example display that may be generated by the system to obtain user approval according to some embodiments;

FIG. 19 shows an example flow for accessing sensitive data according to some embodiments;

FIG. 20 shows an example flow relating to secrets management according to some embodiments;

FIG. 21 shows an example flow relating to handling a one-off database query according to some embodiments;

FIG. 22 shows an example flow relating to a sensitive data access using HTTP according to some embodiments; and

FIG. 23 shows an example flow showing an escalation to AWS Lambda according to some embodiments.

### DETAILED DESCRIPTION

As discussed, some embodiments relate to a platform that enable users to create workflows for processing events of various types. In particular, users are provided templates for performing common cybersecurity and productivity operations that are able to be provisioned in real time. In some embodiments, these templates may process different types of events of various kinds, and deploying them reduces the effort required for creating and maintaining new workflows.

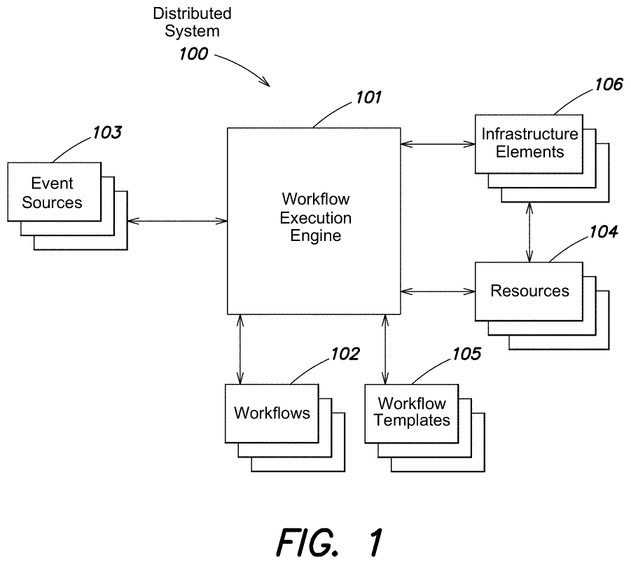

FIG. 1 shows one example of a distributed computer system 100 used to create and manage workflows according to some embodiments. In particular, system 100 processes events originating from one or more event sources (e.g., event sources 103). Such event sources may be, for example, a computer system operated by an end user performing some operation within system 100. For example, the user may send a message from a messaging application, access an application, or perform any other operation within distributed system 100. Such operations generate one or more events which are then used to trigger one or more workflows that process the event.

Received events are processed by a workflow execution engine (e.g., engine 101) which instantiates one or more workflows responsive to the received events. The workflows are instantiated based on templates (e.g., workflow templates 105) which are configured for particular types of events and resource types. The workflows include handler code that determines how the event is handled.

In some embodiments, the executed code performs actions on one or more infrastructure elements (e.g., infrastructure elements 106) in the distributed system 100. In some embodiments described herein, an infrastructure-as-code paradigm is used wherein infrastructure is provisioned and accessed through software via declarative code rather than have to manually configure custom code for specific deployments (e.g., within a cloud-based implementation). Such environments include, for example, cloud-based systems such as Terraform Cloud available from HashiCorp, although it is appreciated that there are other environments that may be used.

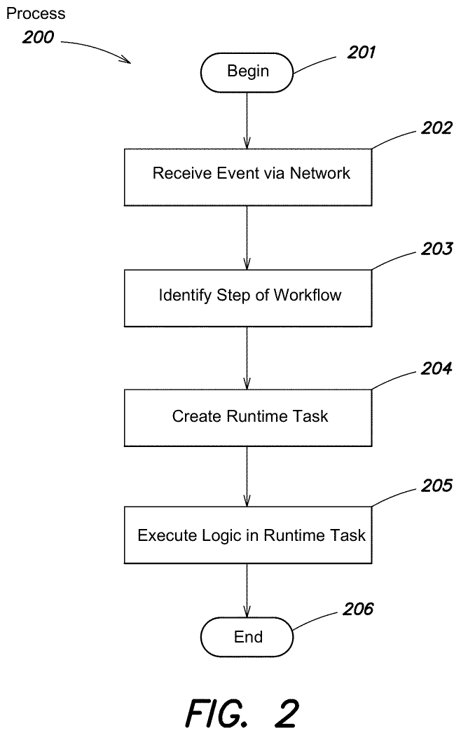

In some embodiments, workflows may be used to access resources such as databases, data elements, physical systems or other types of resources (e.g., resources 104), and such workflows may be provided to enable business processes that use these resources. To this end, certain templates may be provided to access and otherwise perform operations using these resources. FIG. 2 shows a process 200 for processing events according to some embodiments. At block 201, process 200 begins. At block 202, the system receives an event via one or more communication networks (e.g., the Internet, an enterprise network, or combination of networks). At block 203, responsive to the received event, the system identifies a step of a workflow to execute, and at block 204, the system creates a runtime task to handle the event. At block 205, the system executes logic in the runtime task to process the event in some manner defined by the workflow. The system, in some embodiments, responds to one or more events in real time in a continuous manner, until at block 206, process 200 ends.

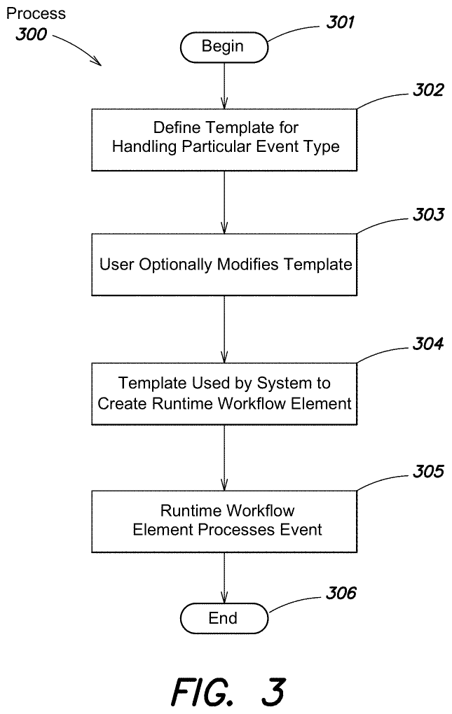

FIG. 3 shows a process 300 for programming workflow elements according to some embodiments. As discussed above, an architecture may be provided that permits users to more quickly develop workflows by using templates. At block 301, process 300 begins. At block 302, a template is defined for handling a particular event. For example, there may be a particular template that performs a one-off query to a sensitive database (e.g., without allowing a user to access the entire database without restriction). In this case, a template may be used that executes a specific query of a database based on a received event (e.g., a user-interface action performed by a user at an end system). At block 303, the programmer/user may modify the template (e.g., to change its default behavior, to perform additional actions, to execute different code, perform a notification, execute another workflow, etc.). The template, when completed, may be then used by the system to respond to events to create one or more runtime workflow elements. At block 305, the runtime workflow element created processes the event (e.g., by executing the one-off query), and process 300 ends at block 306. In some embodiments, the system continually monitors for events and instantiates workflows as necessary based on the received events.

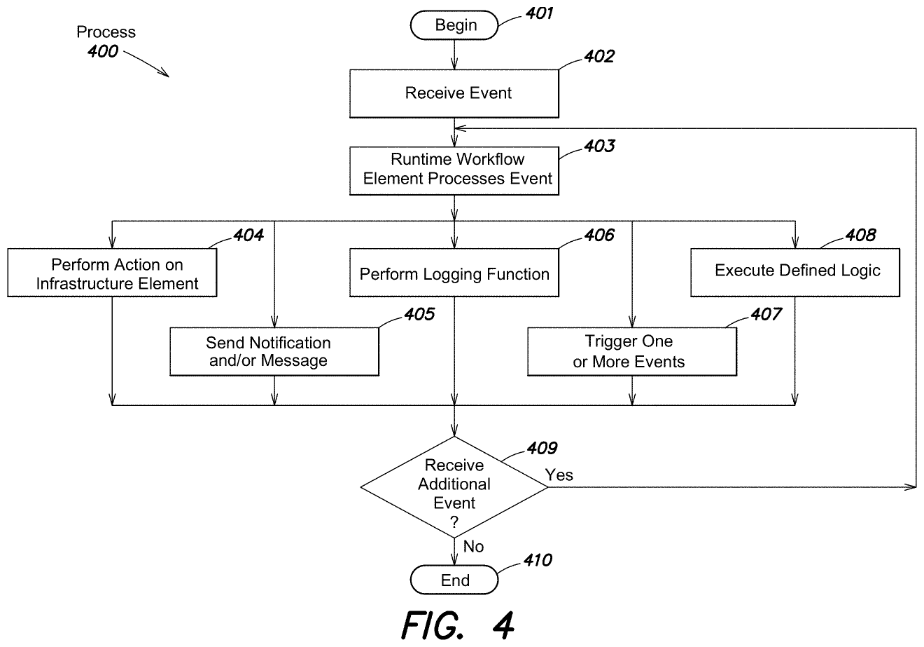

FIG. 4 shows a process 400 for handling events and executing workflows according to some embodiments. As discussed above, the system can process a number of events and instantiate workflows to perform any number of actions. In particular, at block 401, process 400 begins.

At block 402, the system received an event. A runtime workflow element is instantiated as discussed above, and the instantiated workflow processes the event (e.g., at block 403). As discussed, the workflow element may be configured to perform an action on one or more infrastructure elements (e.g., at block 404). Further, the system may be configured to send a notification and/or message responsive to the event. For example, an SMS or Slack message may be sent to one or more users, or any other type of message. Also, the system may perform one or more logging or auditing functions (e.g., at block 406). For instance, the system may write to a log file, database, or other auditing system. Further, the system may trigger one or more events (e.g., at block 407), which may lead to other workflow elements being created. A programmer user may also be permitted to create and execute defined logic (e.g., custom logic provided by the user and/or standard logic defined in the template). The system may continually scan for events and process them (e.g., at block 409, the system determines whether there are any additional events). Process 400 ends at block 410.

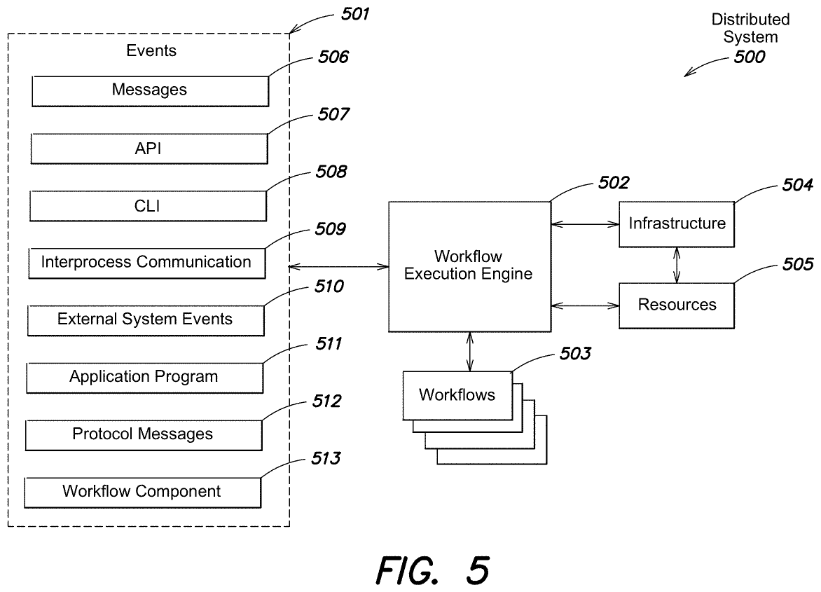

FIG. 5 shows a workflow execution engine 502 that is configured to process various event types that may occur within a distributed system 500 according to some embodiments. In particular, a workflow execution engine 502 may be provided that is configured to receive and process one or more events 501 that may originate within distributed system 500. Workflow execution engine 502 may create one or more workflows 503 responsive to receiving one or more events 501.

Such events may include or be originated from, for example, messages 506, an API 507, command line interface (CLI) 508, external processes via interprocess communication 509, external system events 510, an application program 511, protocol messages 512 or other signal types, workflow components (e.g., other workflows), among other computing entities and/or signal types. In short, workflow execution engine 502 may be configured to respond to many different types of signals and/or data occurring at various locations within distributed system 500. In some embodiments, it is appreciated that in infrastructure may be provided that permits users to quickly develop workflows that respond to many different types of events (e.g., events 501) for the purpose of performing various functions throughout distributed system 500. In some embodiments, such events may trigger processes that perform actions on infrastructure 504 and/or resources 505 of distributed system 500.

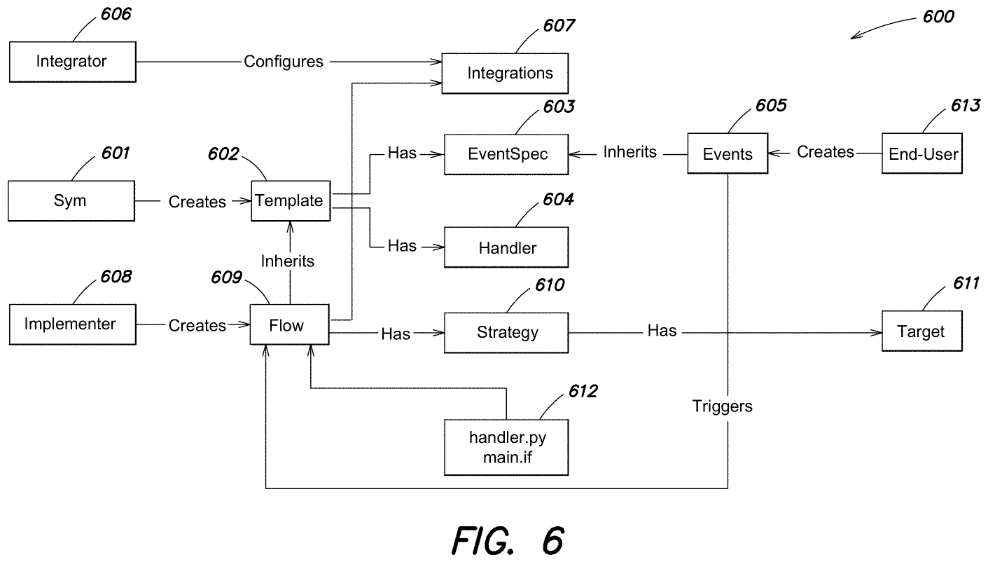

FIG. 6 shows an example software architecture 600 that may be used to process events using workflows within a distributed system (e.g., distributed system 500 of FIG. 5) according to some embodiments. In particular, a software architecture may be provided that uses templates to define behaviors on how events generated by users (e.g., end-user 613) may be handled by the system (referred to herein as “Sym”). These templates are abstractions of workflows that can be created (e.g., instantiated) by an implementer in the form of a flow. As discussed, in some implementations, these templates are analogous to abstract classes in object-oriented programing, while flows are analogous to fully defined and parameterized classes that inherit from the abstract templates. FIG. 6 shows an example software architecture 600 that shows relationships between various entities:
Template (e.g., template 602)—Abstract definition of a workflow. A template defines a series of abstract Steps in the execution flow, with each step associated with an abstract handler (e.g., written in Python) that would be implemented in a flow. The handler for each step specifies how the system should handle an Event (e.g., events 605) of a given EventSpec.
Flow (e.g., flow 609)—Customer and use-case specific definition of a workflow. Flows are defined by Implementers (e.g., implementer 608) by writing code that extends a Template in a similar way a class extends an abstract class in Object Oriented Programing.
   In some example implementations, the handler.py and main.tf files of element 612 are Python and Terraform files respectively that are written by Implementers to define a Flow. The Terraform file declares the workflow and the services that the system ought to connect to, while the Python file defines the custom logic of the flow.
Target (e.g., target 611)—A representation of a resource in a company's system that is managed by the system. This can be a sensitive database or a piece of the infrastructure that a User (e.g., end-user 613) might request access to via the system (e.g., a Sym platform or “Sym”).
Strategy (e.g., strategy 610)—A codified representation of how Sym should interact with a set of Targets. A Strategy is defined by the Implementer and may include information about how access to certain Targets shall be granted. Both Target and Strategy are subcomponents of a Flow. A Template or a Flow may or may not always have a Target or Strategy associated with them, depending on the type of Template. In the case of a sym::approve Template, Strategy and Target are associated with a Flow.
Handler (e.g., handler 604)—Handlers are methods that customize the logic of a flow. In some embodiments, there are three types of handlers referred to as reducers, hooks and actions:
   Reducers take in an Event and return a single value, and are prefixed with get_.
   Hooks allow you to alter control flow by overriding default implementations of
   Template steps and are prefixed with on_.
   Actions allow you to subscribe to Events so as to enact various side-effects and are prefixed with after_.
Events (e.g., events 605)—Events are created by the user interface when the User tries to interact with Sym. Events follow the patterns defined in EventSpecs, which are part of the definition of Templates.

In some implementations, there are at least three types of user types (or personas) who interact with the system (or Sym platform of “Sym”) in different ways. These are:
Users (e.g., end-users 613) are typically employees at a company who need to use Sym to do their daily jobs, such as requesting access to a sensitive file.
Integrators (e.g., integrator 606) are the people who deploy Sym at a company. They are responsible for configuring Integrations so that Sym can interact with the company's existing system components.
Implementers (e.g., implementer 608) are people who author new Flows. A person is a Sym Implementor if their company has set up Sym, and wants to use it to roll out a new workflow.

One example implementation is a workflow template for approval which functions as a just-in-time access to sensitive resources. In some embodiments, other templates may be defined with different behaviors which process and handle different events. Integrators may be permitted to define and customize their own templates to expand and customize the system.

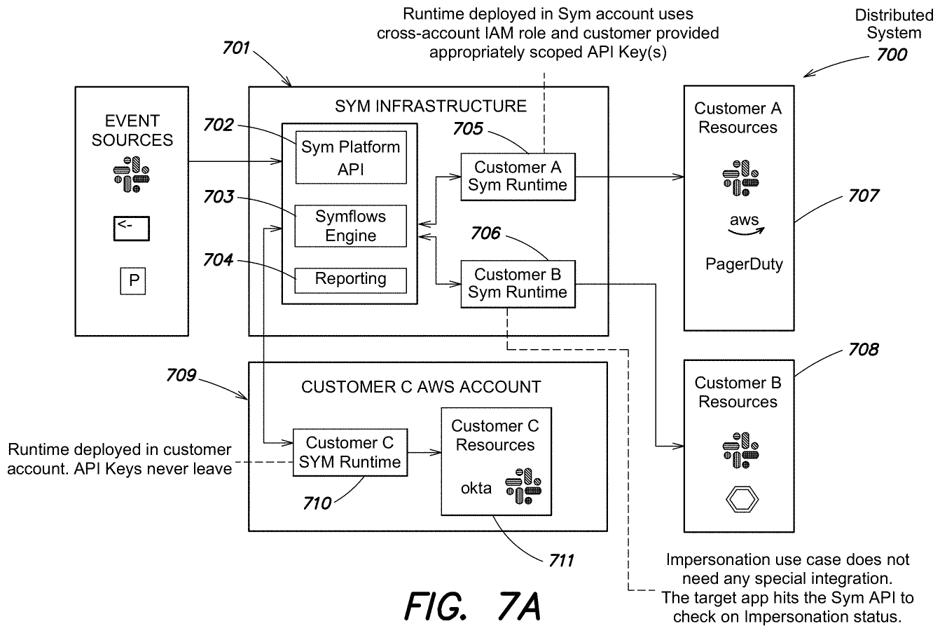

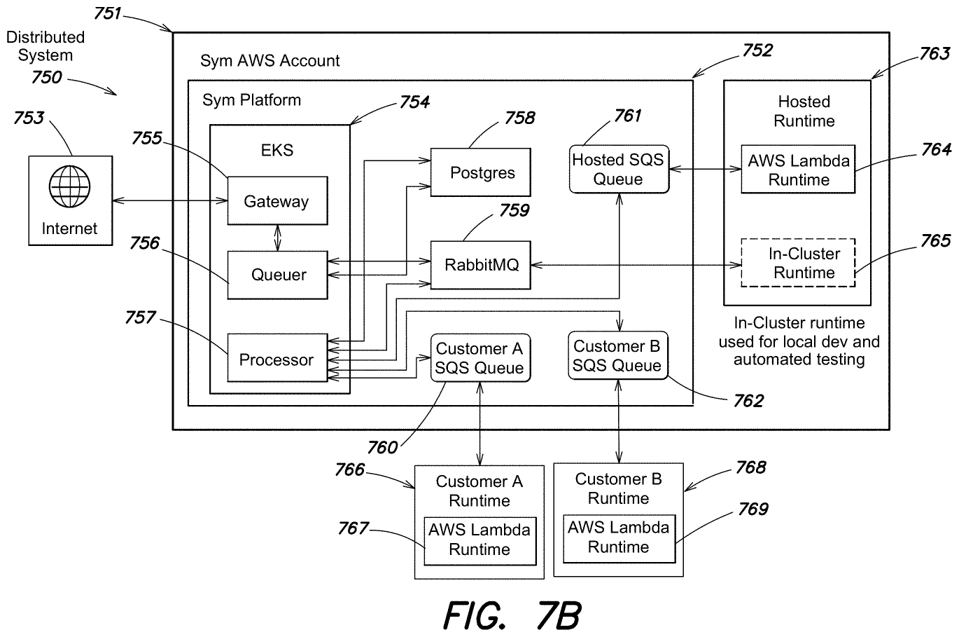

FIG. 7A shows an example implementation of a workflow management infrastructure according to various embodiments. In particular, the system may be implemented in a distributed manner within a distributed computing system 700. In some embodiments, various components of the system (e.g., Sym infrastructure 701) may be implemented within a customer's enterprise network, the Internet, or other network.

In some implementations described herein, the Sym infrastructure acts as an event bus, where incoming requests from various event sources, including CLI, messaging services like Slack or MS Team, HTTP API endpoints, etc. are processed by the Sym infrastructure according to the logic defined in the corresponding flow. The Sym infrastructure includes an API (e.g., the Sym Platform API 702), a workflow engine (e.g., Symflows engine 703), and a reporting component 704. In some embodiments, to access customer resources (e.g., customer A resources 707), the system also employs a runtime that uses a cross-account IAM role and one or more API keys. The Sym infrastructure may be capable of supporting multiple customers and deploying multiple workflows at various premises.

For instance, the Sym infrastructure may support accessing customer A resources 707 via a customer A Sym runtime 705, accessing customer B resources 708 via a customer B Sym runtime 706, and customer C resources 711 via a customer C Sym runtime 710. Notably, customer C Sym runtime may be implemented within a customer's AWS account whereby the API keys never leave their account. Inherently, the system is secure as the Sym infrastructure is processed through the Sym API.

The Sym platform receives the incoming Event, identifies the specific Step of a Flow that the Event is supposed to trigger, creates a RunTask that encapsulates the execution that needs to happen for that Step, and sends the RunTask to the Sym Runtime via an InternalMessage. The Runtime then executes the logic in the RunTask. The Runtime is the component of the Sym system that is responsible for executing handlers. Because of this, it is also the only component of Sym that has the credentials and ability to interact directly with client resources. The execution for each RunTask is done in a new Runtime lambda instance. These Runtimes may be either hosted within the Sym infrastructure or hosted in the customer's infrastructure for enhanced security and separation.

Because the system provides much of the logic of these workflows are pre-implemented in the system-provided libraries. For example, if a customer wants to implement a workflow where users can request access to a sensitive AWS S3 bucket by making a request through Slack, they would otherwise have to implement their own Slack bot, figure out how to programmatically change permission settings on AWS, build a database to keep track of who has request access to what, etc. However, because the system provides a predetermined template for implementing this same workflow, the implementer user would merely have to provide the requisite access credentials for AWS and Slack, define who should be able to request or approve a request, and the rest will be handled by the system. If the customer desires to modify the default behavior of the workflow defined in the template, they can write handlers (e.g., in Python) to execute some custom logic.

FIG. 7B shows a more detailed architecture that may be used in a workflow management infrastructure in a distributed system 750 according to various embodiments. In some implementations of the Sym Platform 752, an asynchronous queuer/processor paradigm may be used to process incoming requests. As shown in FIG. 4B, a Sym AWS account 751 executes the platform which comprises a number of components. The platform includes a processing entity (e.g., an Amazon EKS) including a Gateway 755, Queuer 756, and Processor 757. The Sym Platform accesses various runtimes for different customer (e.g., Customer A runtime 766, Customer B runtime 768, Hosted Runtime 763, etc.) to access (in the case of AWS), various AWS Lambda Runtimes (e.g., AWS Lambda Runtime 767, AWS Lambda Runtime 764, AWS Lambda Runtime 769, etc.).

The Queuer 756 is a lightweight service that parses events that come in from inputs such as a Sym Slack app and puts them onto a queue 759 (e.g., a RabbitMQ queue). In some embodiments, the Queuer-Processor architecture ensures that the Queuer 756 can always be available to clients without getting bogged down on slow-running tasks. Meanwhile, the Processor 757 can be parallelized to run the async tasks.

In some embodiments, the Processor 757 is a celery worker that consumes the events from the RabbitMQ queue enqueued by the Queuer 756 and figures out which step of which flow the event triggers. Once the correct step of the correct flow is identified, the Processor 757 creates a RunTask object and sends the RunTask in an InternalMessage object to the Runtime (e.g., In-Cluster Runtime 765). The Runtime would then execute the specific logic defined in the handler associated with the RunTask. Both the Queuer and the Processor interact with a database interfacing application which provides the database models, serializers, and parsers for the Sym API Queuer and Processor.

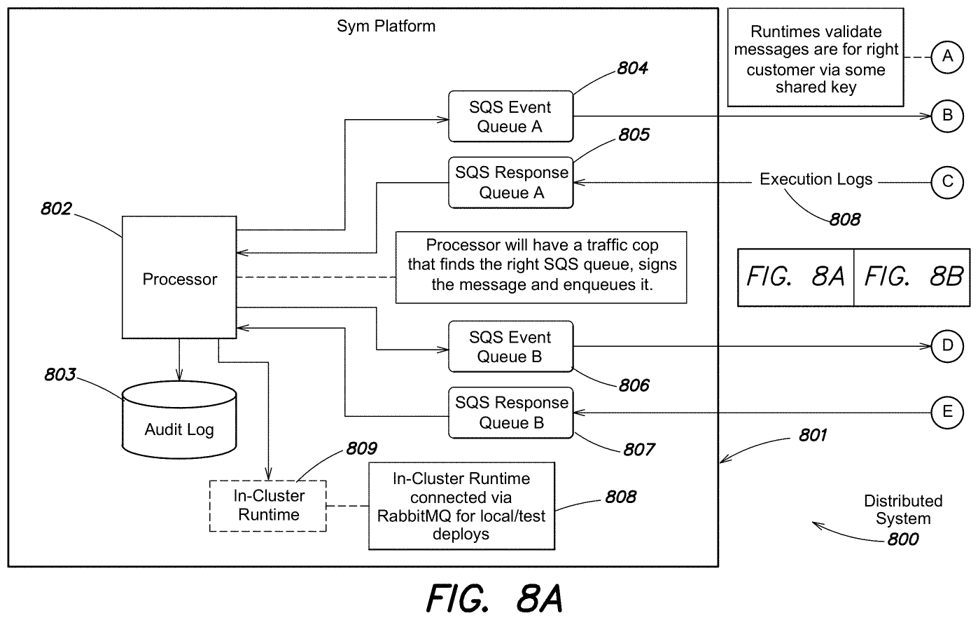

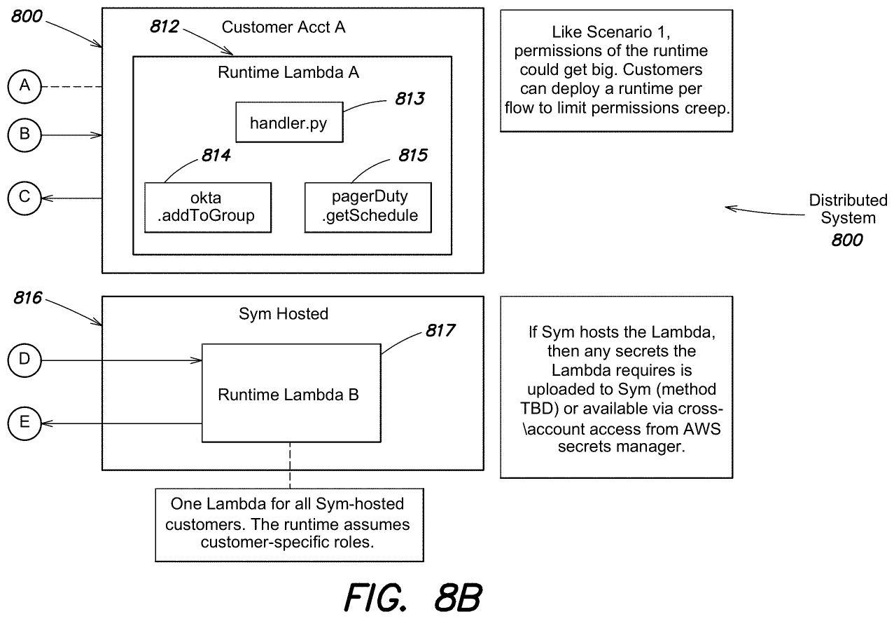

FIGS. 8A-8B show an example implementation of processing messages between a processor and a runtime using queues in an AWS environment. In particular, FIG. 8A shows a distributed system 800 comprising a Sim platform that accesses a customer AWS account as well as a Sym hosted runtime. As shown, the Sym platform includes a processor 802, and audit log 803, and in-cluster runtime 809. The processor receives events and determines which SQS event queue (e.g. queue A 804, queue B 807, etc.) is appropriate for a message and enqueues it onto that queue. The message is retrieved from the queue and communicated to a corresponding runtime, where it is processed and a response is sent (e.g., through a response queue such as SQS response Queue A 805, SQS Response Queue B 807, etc.). For example, a Runtime Lambda A 812 may include handler code (e.g., handler.py 813), and other code to be accessed/executed such as okta.addToGroup 814 and PagerDuty.getSchedule 815. Internal messages between the processor and the runtime are sent via SQS Queues, which are AWSs cloud hosted Message Queuing Service. The Runtime is hosted on event-driven serverless cloud computing platforms such as the AWS Lambda. The Runtime can be hosted on either Sym-owned cloud computing accounts or those owned by the customers for enhanced security.

### Roles

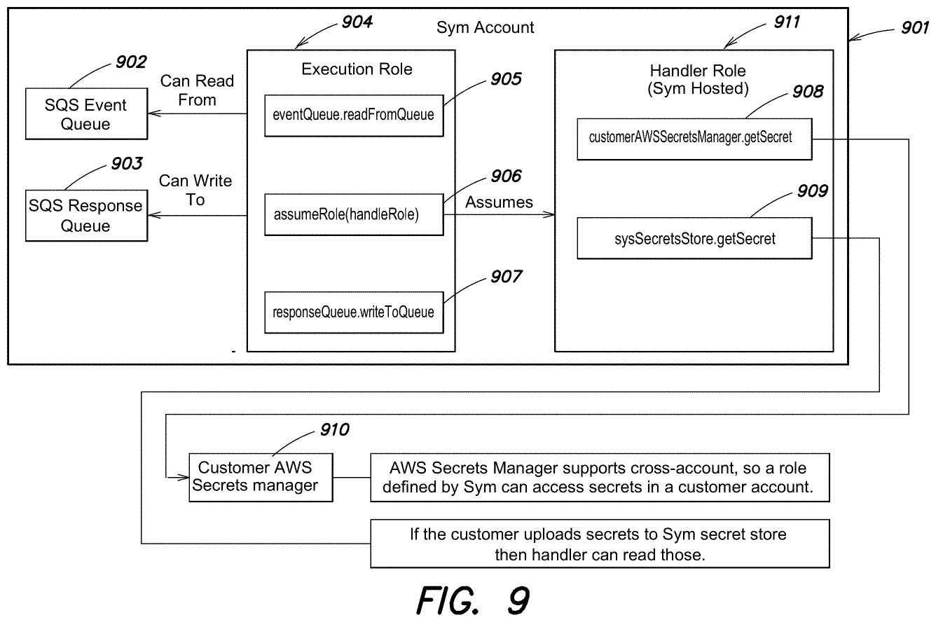

FIG. 9 shows a more detailed example of a customer-handler role according to various embodiments. In particular, a Sym account 901 includes a number of roles through which code may be executed and resources accessed. In particular, an execution role 904 may be capable of reading an SQS event from an SQS event queue 902 (e.g., via eventQueue.readFromQueue 905 process). Similarly, execution role 904 may write SQS responses to an SQS response queue 903 (e.g., via responseQueue.writeToQueue process). As shown, the execution role assumes a handler role (handler role 911) to execute the code to access a particular resource (e.g., an AWS resource). In the example, the handler accesses AWS secrets using customerAWSSecretsManager.getSecret 908. Further, if the customer uploads secrets to the Sym secret store, then the handler may access Sym secrets via sysSecretsStore.getSecret 909.

According to some embodiments, the Sym account assumes a role within a customer account. In particular, within the Sym-hosted runtime, the role used to interface with other components of the Sym infrastructure and the role used to execute the customer-defined handlers is separated. This ensures that the handler execution is not permitted to write back to Sym in any unintended ways. Further, it allows for the handler role be defined in potentially a different account from the Sym execution role. Therefore, an implementer could use the hosted runtime, but still provision a handler role in their account. Finally, separating out the handler role enables a single Lambda deployment that is still safely multi-tenant.

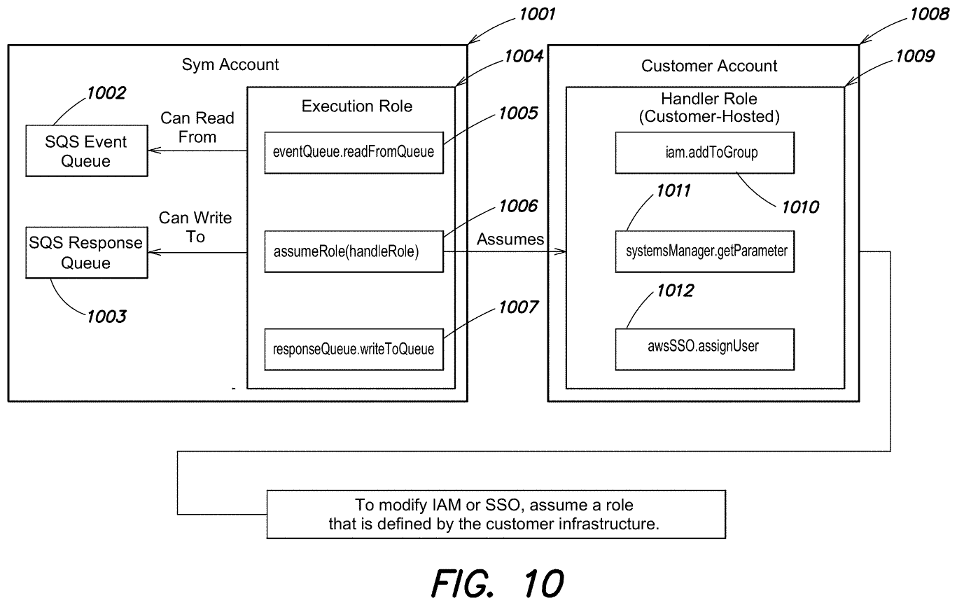

For example, FIG. 10 shows a more detailed example of a customer-handler role according to various embodiments where there is a customer-hosted handler (e.g., customer-hosted handler 1009). Similar to the system shown in FIG. 9, a Sym account 1001 includes a number of roles through which code may be executed and resources accessed. In particular, an execution role 1004 may be capable of reading an SQS event from an SQS event queue 1002 (e.g., via eventQueue.readFromQueue 1005 process). Similarly, execution role may write SQS responses to an SQS response queue 1003 (e.g., via responseQueue.writeToQueue process 1007). As shown, the execution role assumes a handler role (handler role 1009) to execute the code to access a particular resource (e.g., a customer-based resource that may be hosted in a customer premises). Here, the handler role 1009 may be used to access iam.addToGroup 1010, systemsManager.getParameter 1011, and awsSSO.assignUser 1012 functions at the customer-hosted site, and the handler role assumes a role that is defined within the customer infrastructure.

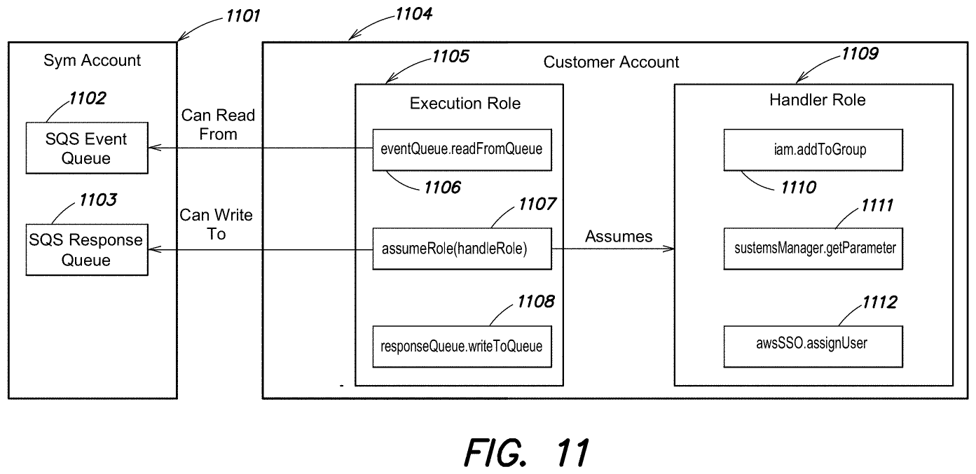

FIG. 11 shows a more detailed example of an execution role and a customer-handler role being executed by a customer account according to various embodiments. Similar to the systems shown in FIGS. 9 and 10, a Sym account 1101 includes a number of roles through which code may be executed and resources accessed. However, here an execution role 1105 may be executed from the customer account 1104. Execution role 1105 may be capable of reading an SQS event from and SQS event queue 1102 (e.g., via eventQueue.readFromQueue 1106 process). Similarly, execution role 1105 may write SQS responses to an SQS response queue 1103 (e.g., via responseQueue.writeToQueue process 1108). As shown, the execution role assumes a handler role (handler role 1109) to execute the code to access a particular resource (e.g., a customer-based resource that may be hosted in a customer premises). Here, the handler role 1109 may be used to access iam.addToGroup 1110, systemsManager.getParameter 1111, and awsSSO.assignUser 1112 functions at the customer-hosted site, and the handler role assumes a role that is defined within the customer infrastructure.

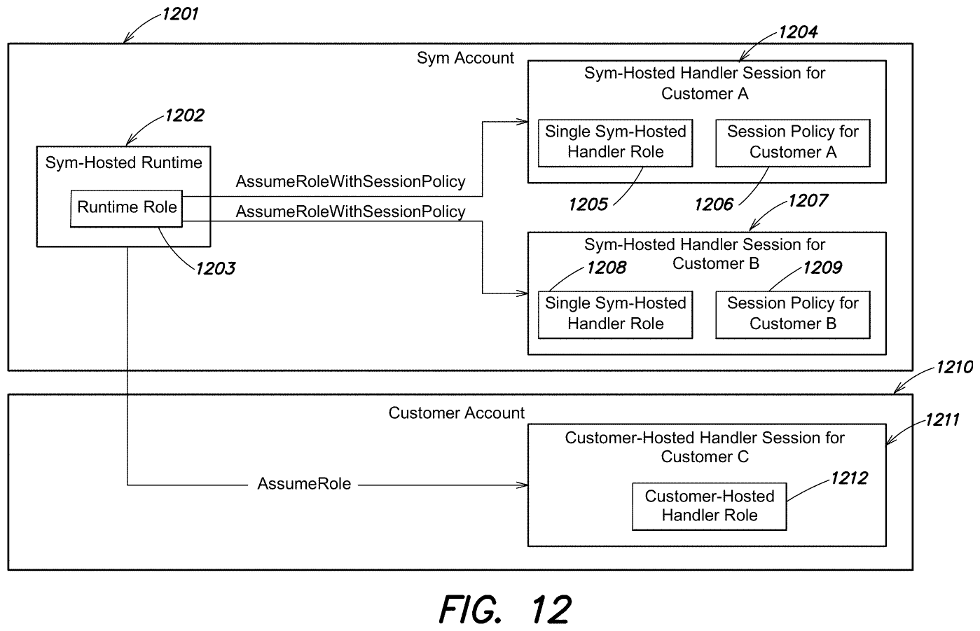

FIG. 12 shows an alternative configuration that supports multi-tenancy, i.e., multiple customers may be supported from a single deployment of a Sym-hosted runtime. In particular, FIG. 12 shows a Sym account 1201 with a Sym-hosted runtime 1202 that executes with a Runtime Role 1203. Here, access may be restricted using session policies. For Sym-hosted handler roles, when the system assumes the role, an additional session constraint may be added that limits handler access to the secrets and accounts that are specific to the requesting customer. For customer-hosted Lambda roles, the system may simply assume the handler role. This design relies on the Lambda entry point being able to reliably assume the right customer role or session for a given input event.

In the example shown in FIG. 12, in a Sym-hosted handler session for customer A 1204, the system uses a single Sym-hosted handler role 1205 and a session policy for customer A 1206. For a Sym-hosted handler session for customer B 1207, the system uses a single Sym-hosted handler role 1208 (same as 1205) and a session policy for customer B 1209. The system may also access handlers in a customer account (e.g., customer account 1210), by accessing a customer-hosted handler session for customer C 1211 using a customer-hosted handler role 1212.

### Provisioning Sym Flows

As discussed above with reference to FIG. 6, flows are derived from templates and are defined by the customer (e.g., using Terraform and Python files). In some embodiments, the customer-written Terraform file declares the parameters required to instantiate an abstract Sym Template into a Flow. This may include a declaration of the resources that the Sym Runtime to connect with and the manner in which to connect with them, as well as the Sym Template that the Flow uses. The Python files may be used to define the handlers (e.g., reducers, hooks, actions) which affect the Runtime's behavior when handling an event. For example, a customer may define an action handler that triggers custom logging logic for future audits after an approval event has been processed by the Runtime.

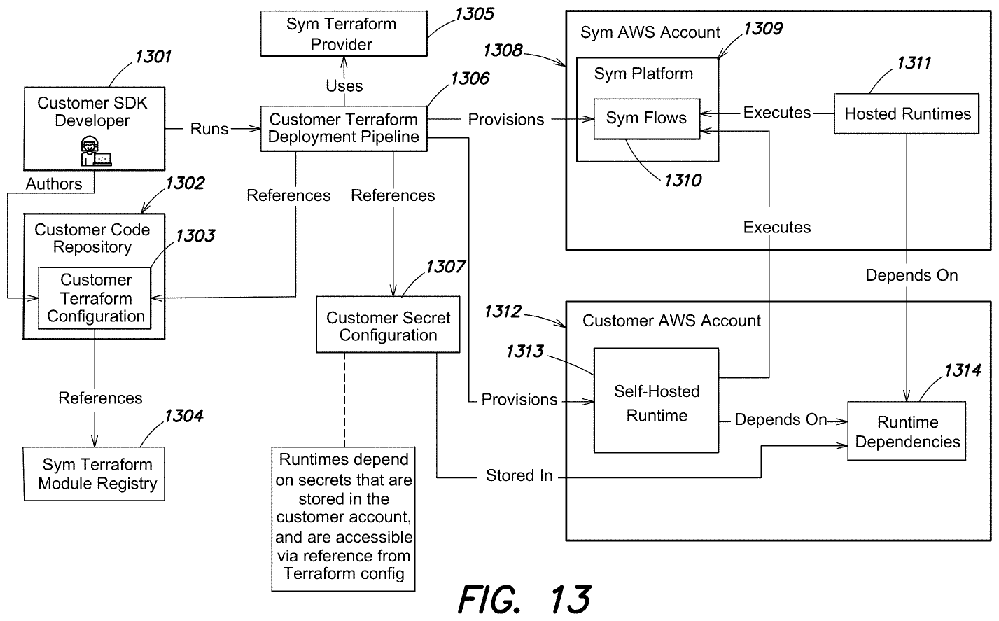

FIG. 13 shows a more detailed architecture for developing customer code in accordance with some embodiments. For instance, a customer SDK developer 1301 authors code in a customer code repository 1302. For example, the system may store Python and terraform files in the customer code repository 1302. The customer code repository may store for example, a customer terraform configuration 1303. When a customer decides to instantiate a new Flow, they can run a “terraform apply” command, which triggers the Terraform Deployment Pipeline 1306 that uses the Sym Terraform provider 1305. The Terraform Deployment Pipeline 1306 compares the state of the system to the intended state declared in the customer's Terraform secret configuration 1307, and then updates the system to match the intended state. The Sym-specific Terraform modules and the Sym Terraform provider are hosted in Sym's Terraform Registry.

The system may then provision Sym flows 1310 within the Sym AWS account which are executed by hosted runtimes 1311. Similarly, from the customer AWS account, the self-hosted runtime may execute Sym flows which depends on runtime dependencies 1314 stored in the customer's secret configuration 1307.

### Example Integration

The following example illustrates how Sym may integrate with third party services such as Pagerduty. As described above with respect to Sym personas, Integrators are the people who deploy the Sym platform at a company. They are responsible for configuring Integrations so that the platform can interact with the company's existing system components. Implementers are people who author new Flows. A person is a Sym Implementer if their company has set up Sym and wants to use it to roll out a new workflow.

In this example of a “PagerDuty” function integration, the Integrator is responsible for installing PagerDuty integration, which involves getting an API token from PagerDuty and declaring a “sym_integration” Terraform resource for this integration so that Implementers can refer to it in their flows. The sym_integration resource includes a setting for the secret where the API token is stored. The Implementer can then use the PagerDuty integration ID (referring to a sym_integration Terraform resource) as part of their flow definition.

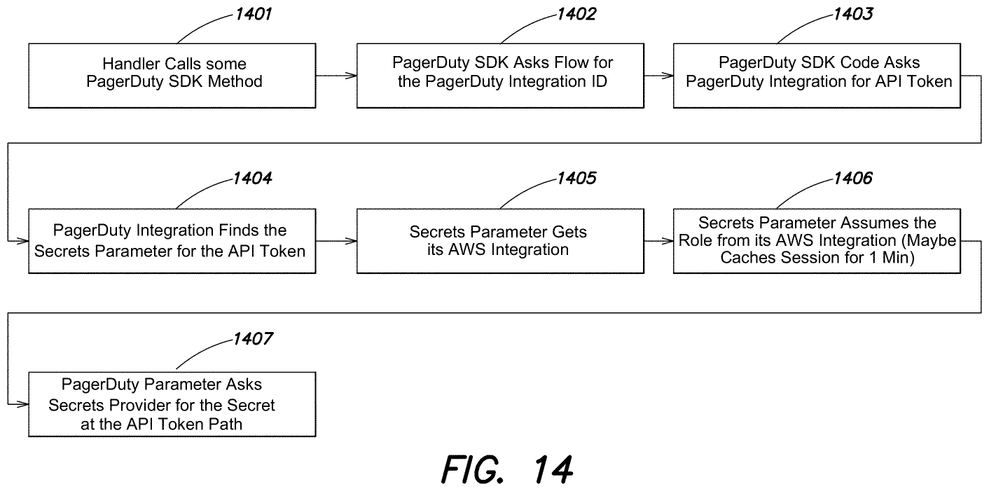

FIG. 14 shows example steps involved to authenticate the integration with PagerDuty during execution. At block 1401, a handler method defined in the Flow definition may call some (part of the Sym SDK) method to perform an action on PagerDuty, which triggers the chain of steps to eventually retrieve the PagerDuty API token from AWS Secrets Manager (or some equivalent cloud-based secrets provider), so that Sym can affect an action in PagerDuty using the PagerDuty API token to authenticate. At block 1402, PagerDuty SDK asks a flow for the PagerDuty integration ID. At block 1403, the PagerDuty SDK code asks PagerDuty integration for an API token. At block 1404, PagerDuty integration finds the secrets parameter for the API token. At block 1405, the secrets parameter gets its AWS integration. At block 1406, the secrets parameter assumes the role from its AWS integration. In one example, the system may cache a session for a predetermined time (e.g., one minute). At block 1407, PagerDuty parameter asks the secrets provider for the secret at the API token path.

### Sym Example Use Cases

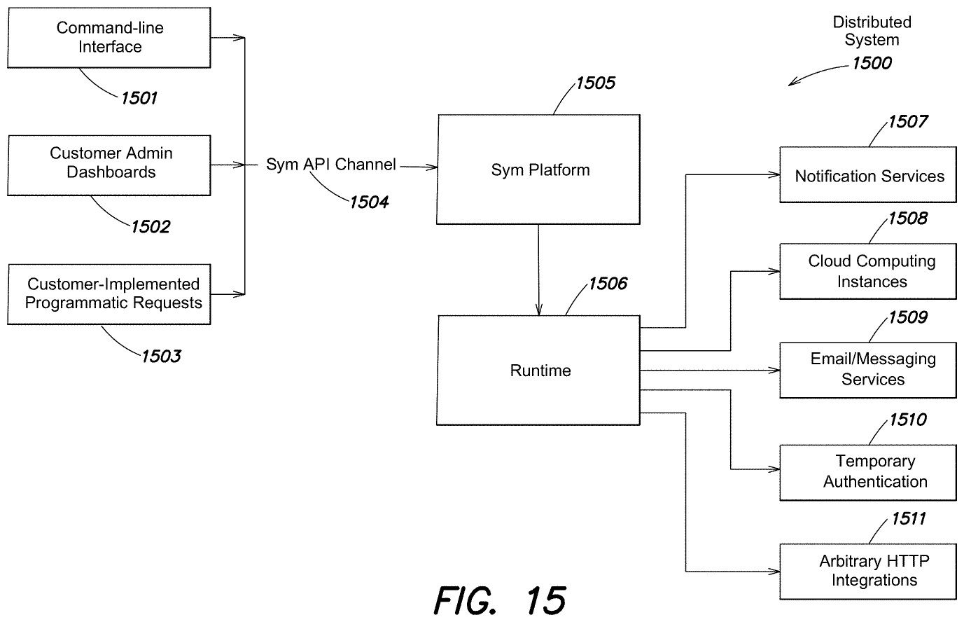

As discussed above, Sym may be used as an event bus for handling different types of events. More particularly, Sym may provide a secure API channel that authenticates the user and receives programmatic requests to the Sym platform. This API channel allows the Sym system to act as a central event bus for handling types of events according to behaviors customized in Flows. As shown in FIG. 15, a number of computer-based entities may access a Sym API channel (e.g., Sym API channel 1504). For instance a command line interface 1501, customer administrative dashboards 1502, customer implemented programmatic requests 1503, or other systems may access the same API channel 1504.

Sym platform 1505 receives events via this API channel 1504 and passes off messages to be processed by runtime 1506. In turn, runtime 1506 accesses one or more resources (customer, third party, etc.) for the purpose of performing various functions. Some of these resources include, for example, notification services 1507, cloud computing instances 1508, email/messaging services 1509, temporary authentication 1510, arbitrary HTTP integrations 1511, among other types of resources.

Use of this API event bus is discussed below in relation to example implementations.

### Self-Approve Example

In emergency situations, it may be needed for an engineer or other user to be able to take immediate actions on a system instead of waiting for approvals. To deal with these special situations, an Implementer can write a handler for a sym:approve Flow that checks for the “urgency” field of an event and allow for self-approval in the case of emergency. Just like under normal conditions, Sym could be configured to log these approval requests to the audit log, so that auditors can inspect the circumstances of the approval after the emergency and hold the requester accountable. It is also possible to implement in the Flow handler a logic to trigger a post-incident review once the emergency is over. The following code is an example code that implements an emergency approval:

```
from sym.sdk.annotations import reducer
from sym.sdk.integrations import slack
@reducer
def get_approvers(request):
  fvars = evt.flow.vars
  if evt.payload.fields[“urgency”] == “Emergency”:
    return slack.channel(fvars[“emergency_channel_name”],
    allow_self=True)
  return slack.channel(fvars[“normal_channel_name”])
```

### Auto-Approve Example

In some cases, not all approval requests need to be manually approved by human reviewers. Instead, automatic approval based on a pre-specified set of rules would suffice. The following are a few examples of auto-approval logics that can be implemented with the Sym Python SDK.

```
Approve if on-call
from sym.sdk.annotations import reducer
from sym.sdk.integrations import slack, pagerduty
from sym.sdk.errors import PagerDutyError
from sym.sdk.templates import ApprovalTemplate
@hook
def on_request(evt):
  if pagerduty.is_on_call(evt.user):
    yield ApprovalTemplate.Events.Approve
({“reason”: “Your request was auto-approved because you are on call”})
@reducer
def get_approvers(evt):
  fvars = evt.flow.vars
  on_call_mgrs =
  pagerduty.users_on_call(schedule_id=fvars[“mgr_pd_id”])
  return slack.group(on_call_mgrs)
```

In the above code sample, an Implementer can easily implement an auto-approve process for users who are on-call. The on_request( ) function is a customer-defined hook handler that checks if the user making a request is on-call and automatically yields an approval if so. For users who are not on-call, the on_request( ) hook would do nothing, while the get_approvers( ) reducer handler handles the standard logic of notifying the on-call managers about the access request.

### Approve on Completion of Training Example

Implementers can also implement auto-approvals that check with some external HTTP API endpoint. For example, there may be a scenario where a user is only allowed to take a certain action if they have completed the requisite training.

```
from sym.sdk.annotations import hook, reducer
from sym.sdk.integrations import slack
from sym.sdk.integrations.dangerous import http
from sym.sdk.templates import ApprovalTemplate
@hook
def on_request(evt):
  body = {“user”: evt.user.email, “request-type”:
  “TRAINING_STATUS”}
  resp = http.post(f“https://training-mgr.healthy-health.co”, body)
  # If the user has not completed training, then reject their request
  if resp[“training”] != “complete”:
    yield ApprovalTemplate.Events.Reject
      ({“reason”: “You must complete required training to make this
      request!”})
@reducer
def get_approvers(request):
  return slack.channel(“#break-glass”)
```

In the code sample above, the on_request( ) hook handler makes an HTTP call to a customer-specified API endpoint, which returns the training status of the user. Then, the handler is able to make an automatic rejection if the user has not completed the requisite training.

### Role-Based Approval Example

Another common use case is to base the approval decision on the role of the employee making the request or find the relevant set of approvers based on the employee's department. For example, a company may wish to implement a rule where only members of a specific engineering team shall have access to the cloud computing instances related to that team's work. For these use cases, Sym can be integrated with a directory provider such as Azure's Active Directory.

In the following code sample, the get_approvers( ) reducer is implemented such that it checks for the requesting user's department from Azure and finds the oncall manager for that department. Then it messages the group of oncall managers on Slack for approval.

```
from sym.sdk.annotations import hook, reducer
from sym.sdk.integrations import azuread, slack, pagerduty
@reducer
def get_approvers(evt):
  fvars = evt.flow.vars
  azuread_properties = azuread.get_user_properties(evt.user)
  user_dpt = azuread_properties[“department”]
  #Look up the right PagerDuty call schedule based on the user's
  department
  on_cal_mgrs =
  pagerduty.users_on_call(schedule_id=fvars[“user_dpt”])
  return slack.group(on_call_mgrs)
```

### AI/Risk-Based Auto-Approve Example

Sometimes, it takes too much time and effort to manually review every access request, but we also don't want the auto-approval to be entirely based on static variables such as the user's job title. Instead, it's possible to use Sym to implement an auto-approval logic that factors in dynamic variables such as how often the user has accessed this resource in the past, the most recent time the user requested access to the resource, whether other people on the team that the user belongs to has frequently accessed the resource, etc.

In order to implement such a flow, the implementer would first need to configure a data source to read the past access history of the user. Then, the implementer can implement the logic for processing the input variables and making the auto-approve decision in the on_request( ) handler using Sym's Python SDK.

The data source could be configured in a variety of ways. In a basic implementation, the access history can be simply read from the access logs generated by Sym that logs every access request on a resource. For better performance, the implementer can also configure an intermediate data table that pre-computes the access frequency and stores the access frequency for each given user and resource directly.

In terms of the logic for determining whether a request should be auto-approved or require manual review, either a hard-coded set of policy or a machine learning algorithm that is trained on the results of manual reviews can be used. It's also potentially useful to add some randomness to the decision, so that every access request would have some non-zero probability of requiring manual review, and the probability of such can be based on a risk score outputted by a risk assessment algorithm.

From a game theory perspective, the problem of allocating limited time and effort to selectively conduct manual review on access requests can be modeled as a Stackelberg Security Game, where the attacker tries to attack some resource and the defender can only defend a subset of all resources. In such a situation, it can be shown that a “mixed strategy” where the defender stochastically chooses the set of resources to defend at a given time is more effective than a “pure strategy” where the defender chooses the set of resources to defend based on deterministic logic. An algorithm that is used to solve the Stackelberg Security Game can be potentially useful for the purpose of deciding whether to require manual review on a given access request.

### SSH Access Example

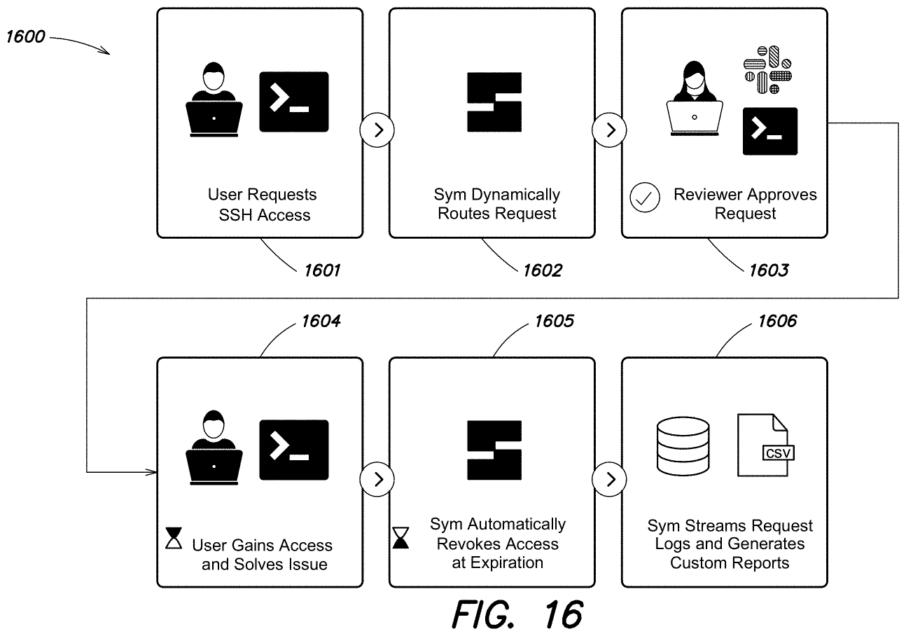

SSH access to sensitive machines is often needed by engineers to do their jobs, but it carries a risk of being compromised. Using Sym to implement just-in-time SSH access can help reduce the default scope of access while allowing the engineers to get access quickly when they need it. As shown in the example process 1600 in FIG. 16, a user (e.g., an engineer) can request SSH access through the Sym CLI at block 1601. Then, at block 1602, Sym dynamically routes the request to the right reviewers and escalates privileges when approved (e.g., at block 1603). After the user completes their task by gaining access and solving issue at block 1604, Sym automatically revokes access at expiration at block 1605 and logs all steps for security and compliance reporting (e.g., by streaming request logs and generating custom reports at block 1606). As compared to conventional methods where a company may need to develop all of the above steps internally, this SSH approval request logic can be simply defined and implemented using the following code snippet.

```
from sym.sdk.annotations import reducer
from sym.sdk.integrations import okta, slack
@reducer
def get_approver(event):
  if event.resource.environment == “prod”:
    approvers = okta.group(“data-security”)
    return slack.user(approvers)
    return slack.channel(“ops”)
```

The get_approver( ) reducer lets the Implementer define the method by which to determine the appropriate channels for approval. In this code sample, if the requested resource is in the “prod” (production) environment, then it sends Slack DM to the list of people in the “data-security” group as specified in the Okta identity provider; if the resource is not in the sensitive prod environment, then it simply routes the request to the “ops” channel on Slack where anyone in that channel can approve.

### User Impersonation Example

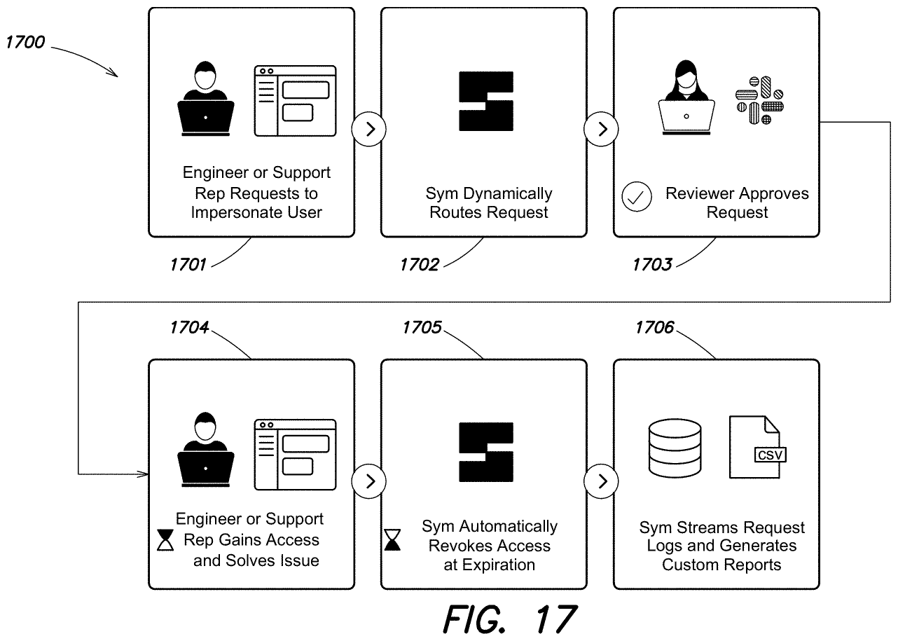

User impersonation is a common way to provide customer support but is vulnerable to attackers who wish to abuse the mechanism. Implementers can use Sym to create just-in-time access to user impersonation Flows to add an additional layer of security as shown in the example flow 1700 shown in FIG. 17. In this flow, the engineer or support rep may first request access to impersonate a user in an admin dashboard owned by the customer at block 1701. At block 1702, Sym dynamically routes the request to the right reviewers and allows impersonation when approved (e.g., when approved by a reviewer at block 1703). After the user completes their task, such as by the user gaining access and solving issue (e.g., at block 1704), Sym automatically revokes access (at block 1705) and logs all steps for security and compliance reporting (at block 1706).

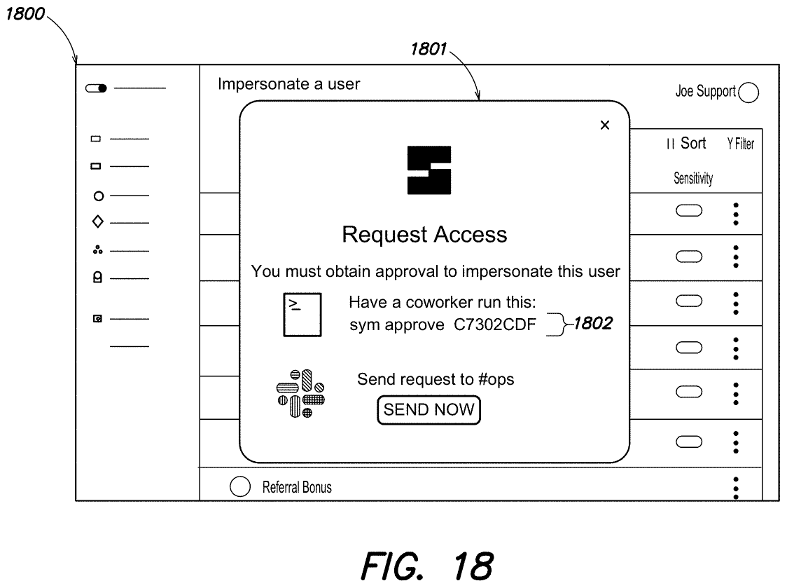

In terms of implementation, a Sym-provided module (e.g., sym.django module) may provide a simple request decorator which wraps the customer's admin dashboard view that would otherwise establish a new user impersonation session (e.g., by setting a cookie). When a user visits the Sym-wrapped page (e.g., a display 1800 as shown by way of example in FIG. 18), they will be presented with a screen 1801 with a form to fill out (based on the fields specified in a customer's sym_flow definition). Upon submitting this form, an event is sent to the Sym API, which will trigger the flow.

```
from sym.django import require_approval
sym_init(token=ENV['SYM_TOKEN'])
@require_approval(flow=“impersonate”)
def impersonation_handler(request):
  # Your admin dashboard logic goes here
  ...
  return HttpResponse(html)
```

The sym.django module is one example of a Sym frontend UI integration with web frameworks (in the example, Python Django). The module makes calls to the Sym API event bus mentioned previously to send impersonation approval requests to the Sym platform.

### Sensitive Data Access Example

Engineers and other users may need to access sensitive data from time to time but granting default access to sensitive databases raises security and privacy concerns.

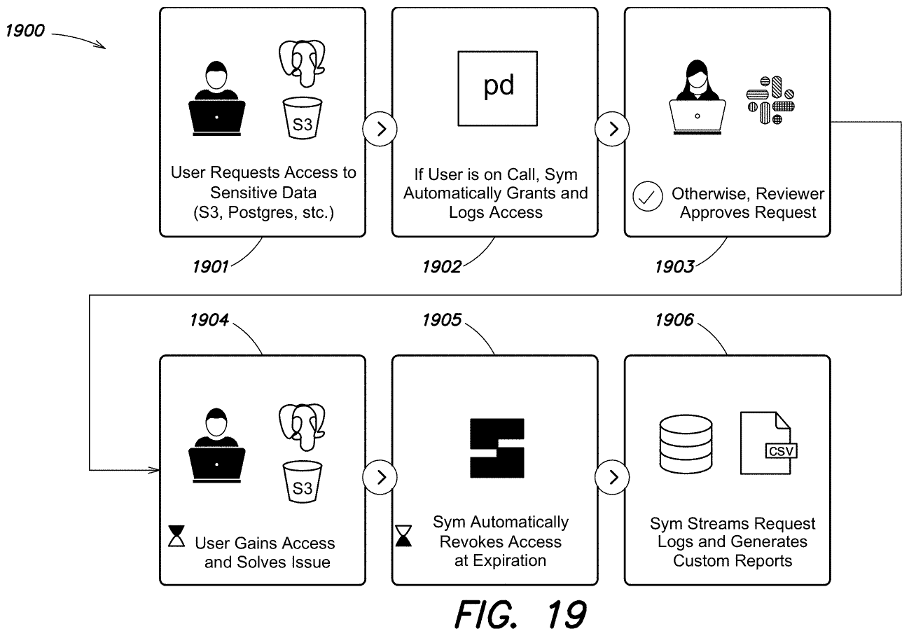

One possible flow to reduce the risk of sensitive data access is shown by way of example in FIG. 19. First, a user (e.g., an engineer) requests access to sensitive data sources like S3 bucket or PostgreSQL databases at block 1901. For oncall users, auto-escalation or a different escalation path can be enabled. For example, at block 1902, Sym automatically grants and logs access if that user is on call. Otherwise, Sym dynamically routes the request to the right reviewers and escalates privileges when approved (e.g., at block 1903). After the user completes their task, such as by the user gaining access and solving issue (e.g., at block 1904), Sym automatically revokes access (at block 1905) and logs all steps for security and compliance reporting (at block 1906).

The following code sample basically implements a simplified version of the logic described above. The get_approvers( ) reducers checks for whether the request is regarding a S3 bucket, and the on_request( ) hook auto approves the user if the user is oncall.

```
from sym.sdk.annotations import reducer, hook
from sym.sdk.integrations import slack, pagerduty
from sym.sdk.templates.approval import events
@reducer
def get_approvers(event):
  if event.resource.type == “s3”:
    return slack.channel(“#access-requests”)
@hook
def on_request(event):
  if pagerduty.on_call(event.user):
    return events.approve( )
```

### Secrets Management Example

Secrets management refers to the access control around sensitive credentials such as tokens, passwords, certificates, encryption keys for protecting secrets and other sensitive data. Implementers can use Sym to gate the access to these secrets. One potential way to implement such a workflow is to integrate Sym with a secret store service such as Hashicorp Vault.

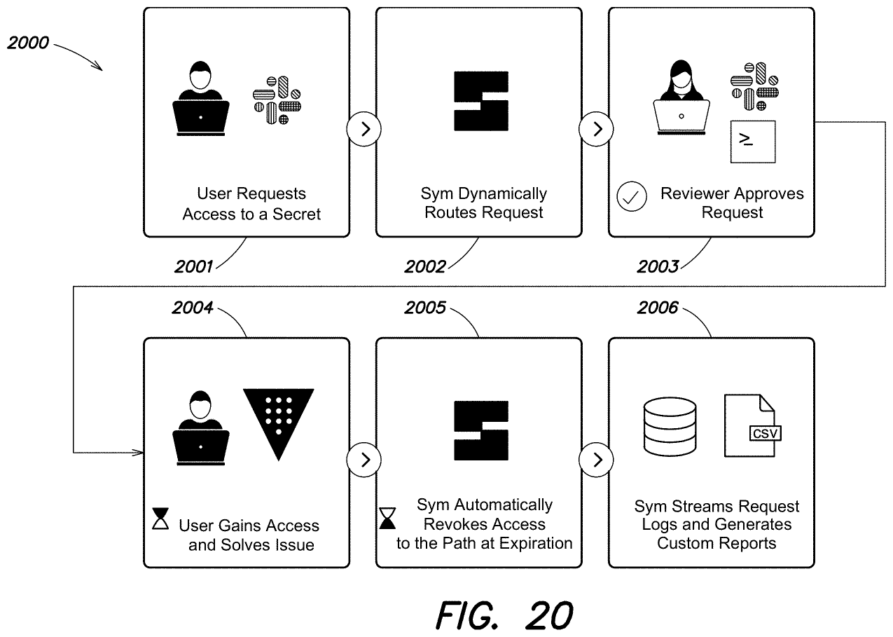

In the workflow 2000 shown in FIG. 20, a user first requests access to a secret (e.g., a vault path) through Slack or CLI (e.g., at block 2001). Then, Sym dynamically routes the request to the right reviewers (at block 2002) and escalates privileges when approved (at block 2003). After the user completes their task, such as by the user gaining access and solving issue (e.g., at block 2004), Sym automatically revokes access (at block 2005) and logs all steps for security and compliance reporting (at block 2006).

The flow for gating access to HashiCorp Vault can be implemented with the following sample of Python and Terraform code. In the Python implementation, the get_approver( ) reducer defines the logic for identifying the appropriate approvers and approving channels to grant the access.

```
from sym.sdk.integrations import reducer
from sym.sdk.integrations import okta, slack
@reducer
def get_approver(event):
  # Interprets the vault command's action
  if event.action.type = = “write”:
    approvers = okta.group(“data-security”)
    return slack.dm(approvers)
  return slack.channel(“#vault-requests”)
```

In the Terraform implementation code sample below, the “sym_target” block declares the “breakglass” credential path that is managed by HashiCorp Vault (declared via the type=“vault” statement). The “sym_strategy” block declares the set of targets to include the “breakglass” target that we defined here, in addition to referencing the integration_id of the HashiCorp Vault integration.

```
main.tf
# Use the Vault Strategy for escalation
resource “sym_strategy” “this” {
  type = “vault”
  integration_id = data.sym_integration.vault.id
  targets = [
    sym_target.breakglass.id
  ]
}
# Expose the breakglass path in Vault as a Target
resource “sym_target” “breakglass” {
  type = “vault”
  label = “Breakglass”
  settings = {
      path = “aws/creds/breakglass-role”
      group_id = “73c2684a-87e9-4f18-82dc-cf542b3f3540”
  }
}
```

From the user's perspective, if the user initiates the request to read the secret (e.g., using using the Sym CLI), the following is an example of how the Sym CLI would prompt the user to provide a reason for the request, wait for approval, and, when approval is granted, show the secrets in the terminal.

$ sym vault read aws/creds/breakglass-role
You don't have access to this path, would you like to request it? (y/n) y
Please specify a reason or ticket number: Fix prod issue 123
Firing event requested for flow: healthy-health:vault-secrets:1.0
Waiting for approval... #z,31;
Your request was approved by Yasyf Mohamedali in Slack!
Reading “aws/creds/breakglass-role”:

| | |
|---|---|
| Key | Value |
| --- | --- |
| lease_id | aws/creds/breakglass-role/4bbbc122-a898-abcd-1234-abcd1234 |
| lease_duration | 768h |
| lease_renewable | true |
| access_key | AKIAQERER2343eADD23R2 |
| secret_key | 2HBDFS23ERFGE34VAFV34QG3RQ4EFQWG34 |
| security_token | <nil> |

### One-Off Database Query Example

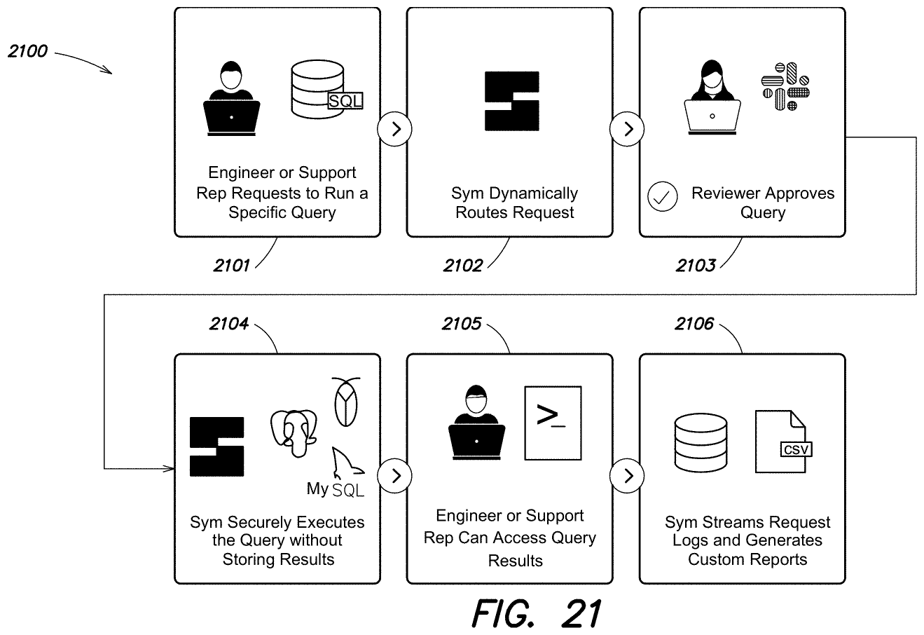

Sometimes, engineers or customer support representatives in a company may need a small amount of specific data from a privileged database. Sym enables the implementation of one-off query execution Flow that can quickly unblock teams without granting the ability to run arbitrary queries against the sensitive database. In the workflow 2100 shown in FIG. 21, an engineer or support representative requests to execute a specific query (e.g., at block 2101). Then, at block 2102, Sym dynamically routes the query request to the right reviewers and executes against the database when approved (e.g., at block 2103). At block 2104, Sym securely executes the query without storing the results, and at block 2105, the engineer, support rep or other user type can access the query results. At block 2106, Sym logs all steps for security and compliance reporting.

The following code sample summarizes the implementation of the Flow using our Python SDK. As shown in previous use cases, the get_approver( ) reducer finds the appropriate set of approvers to approve the request. In the on_escalate( ) hook, the sql.exec( ) function from the sym.sdk.integrations package executes the query in the event against the specified database (event.params[‘db’]).

```
from sym.sdk.integrations import reducer, hook
from sym.sdk.integrations import okta, sql
@reducer
def get_approver(event):
  approvers = okta.group(“db-approvers”)
  return slack.dm(approvers)
@hook
def on_escalate(event):
  sql.exec(event.params[“db”], event.params[“query”])
```

### Arbitrary API Via HTTP Example

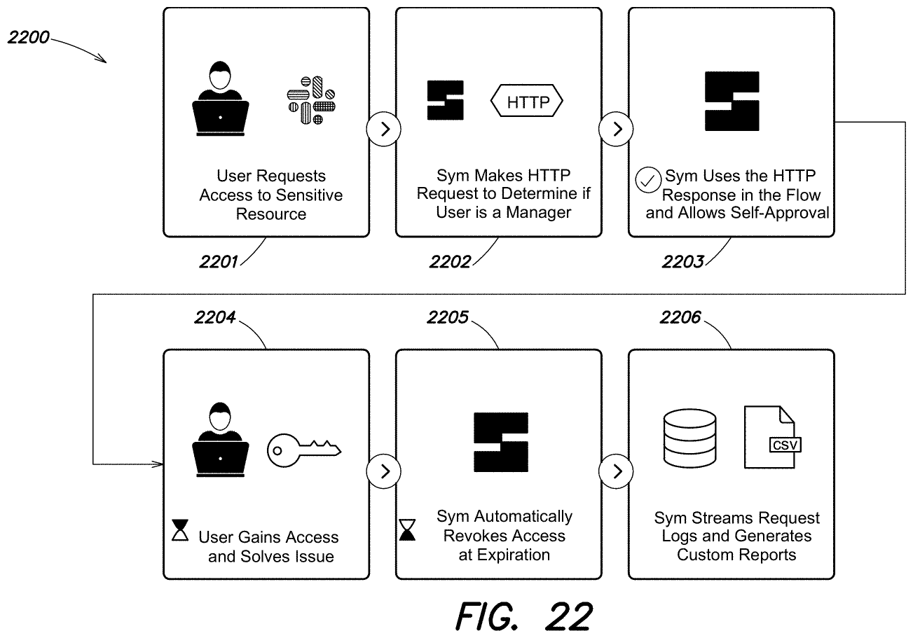

In situations where the existing set of integrations with third party services do not cover the full range of use cases, customers can integrate with tools or custom services via HTTP API endpoints. The following is an example of how a customer might integrate Sym with a custom Identity Provider (IDP) via HTTP as part of an approval flow. In the workflow 2200 shown in FIG. 22, when a user requests access to a sensitive resource via Sym (e.g., at block 2201), Sym makes an HTTP request to the custom IDP to determine if the user is a manager in the company's directory (e.g., at block 2202). If so, Sym can allow self-approval based on the HTTP response (e.g., at block 2203).

In the following code sample, the get_approvers( ) reducer makes an HTTP request to “https://people.healthy-health.co” with a email parameter, and is then able to read the HTTP response where there's a boolean field “is_manager” that indicates whether the user is a manager or not. If the user is a manager, then it returns the user as a self-approver to their own request.

```
from sym.sdk.annotations import reducer
from sym.sdk.integrations import http
@reducer
def get_approvers(event):
  email = event.user.email
  resp = http.get(f“https://people.healthy-health.co?email= {email}”)
  if resp[“is_manager”]:
    # Self-approval allowed via Slack if user is a manager
    return slack.user(event.user)
```

### Error-Handling and Fallback Methods of Approval Example

In situations where the primary method of gaining approval fails for some reason, implementers can write error handling logic using Sym's Python SDK in order to define fallback methods of approval. In the following code sample, the get_approver( ) reducer first tries to check PagerDuty to see if the user is oncall. If the call to PagerDuty fails, then it checks if the request corresponds to an emergency issue. If so, it allows for self approval. Finally, it tries to get the set of oncall managers and ask them for approval. If PagerDuty raises another error for some reason, it catches the error and returns the FALLBACK_APPROVERS as last resort.

The error handling mechanisms illustrated here allows for more dynamic control logic.

```
from sym.sdk.annotations import reducer
from sym.sdk.integrations import slack, pagerduty
from sym.sdk.errors import PagerDutyError
FALLBACK_APPROVERS = [“sym-implementer@healthy-health.co”]
@reducer
def get_approvers(evt):
  fvars = evt.flow.vars
  try:
    # SRE's who are on-call can self-approve
    if pagerduty.is_on_call(evt.user, schedule_id=fvars[“sre_pd_id”]):
      # This is a self-approval in a channel
      return slack.channel(fvars[“on_call_channel”], allow_self=True)
  except PagerDutyError:
      Pass # Fall back to not on-call logic
    # Anyone with an Emergency issue can self-approve
    if evt.payload.fields[“urgency”] == “Emergency”: # Options are
    Normal or Emergency
    # This is a self-approval in a channel
    return slack.channel(fvars[“emergency_channel”], allow_self=True
    try:
      on_call_mgrs =
      pagerduty.users_on_call(schedule_id=fvars[“mgr_pd_id”])
      return slack.group((on_call_mgrs +
      FALLBACK_APPROVERS)[:7])
    except PagerDutyError:
    # If something goes wrong with Pagerduty, we will fall back to
    # a set list of approvers.
    return slack.group(FALLBACK_APPROVERS)
```

### Lambda as Escalation Strategy Example

An AWS Lambda escalation strategy enables Sym to trigger an AWS Lambda execution when a request is approved. One way customers may want to interface with the Sym platform is to use Sym as an event bus that takes incoming requests from a Sym API endpoint, let the Sym platform parse the event according to a relatively lightweight logic defined in a Flow using Sym's Python SDK, and then trigger an AWS Lambda instance (or some other serverless cloud service) to execute some logic that is isolated from Sym. Such an escalation strategy would have multiple advantages:

| | |
|---|---|
| - | By isolating the logic in the AWS Lambda instance from the Sym |
| | Runtime, it creates another layer of security separation such |
| | that sensitive logic/credentials in the AWS Lambda instance |
| | would not be exposed to Sym. |
| - | The same AWS Lambda function may be triggerable by multiple |
| | methods, with Sym being one of many methods. This allows the |
| | customer to create a single API endpoint to receive requests |
| | from multiple sources. |

```
# A strategy uses an integration to grant people access to
targets
resource “sym_strategy” “this” {
  type = “aws_lambda”
  integration_id = data.sym_integration.lambda.id
  targets = [
  sym_target.lambda.my_function
  ]
}
resource “sym_target” “my_function” {
  type = “aws_lambda_function”
  arn = var.my_function_arn
}
```

### Notification and Review Template Example

There are many reasons why a user may need to be notified or reminded to take a certain action as part of a security workflow. For example, there may be some online training course that employees are required to complete, and a company's administrator may wish to notify and remind their employees to complete the training. Alternatively, a security administrator may need to be notified to review a security incident when it occurs.

While the sym:approval Template provides some basic notification functionalities such as messaging users on Slack, a dedicated notification and review Template is needed to handle some more complex aspects of notification, such as the ability to snooze a notification or schedule a notification to be sent out at some time in the future. To handle these additional complexities, Sym provides the “sym:nag” Template, which follows the following steps:
An event, such as the occurrence of a security incident, triggers a flow that implements the sym:nag Template for the purpose of responding to security incidents
Sym calls the corresponding handlers to figure out the following:
   Who should be contacted,
   Which notification channel to use,
   Which priority level it is,
   What the deadline is
   What the snoozing interval should be
   What the completion criteria should be
Sym sends a notification to the appropriate users according to the information returned by handlers in the previous step.
The user has the choice to either respond to the incident now or snooze it
If the user snoozed the notification, a future notification is scheduled
If the user chooses to respond to the incident, the user would need to complete some task, which gets checked by a handler based on some acceptance criteria. If the task is confirmed to be completed, then the notification is resolved.
All interactions between the user and the flow execution gets logged for future audits.

### Risk Assessment Template Example

For regulatory compliance standards such as HIPAA, it may be necessary to conduct risk assessment surveys whenever a major change is made in the system. In order to stay compliant and secure, Sym may provide a Risk Assessment Template that facilitates the manual risk analysis process that security administrators have to undergo whenever a change is made to the system architecture.

The risk assessment Template example includes the following steps:
There are two ways this flow gets triggered:
   A customer-implemented handler that detects changes in the system is periodically called. If the change-detection handler detects a change, it triggers another handler that identifies the appropriate section of the risk assessment datasheet that needs to be updated.
   A user may also manually request a risk assessment review after making some change to the system.
A reviewer is notified of the task to inspect and update the risk assessment datasheet to reflect the latest change in the system.
The risk assessment datasheet gets updated, and an audit log of the actions taken during this workflow gets recorded.

### Data-Leak-Prevention Template Example

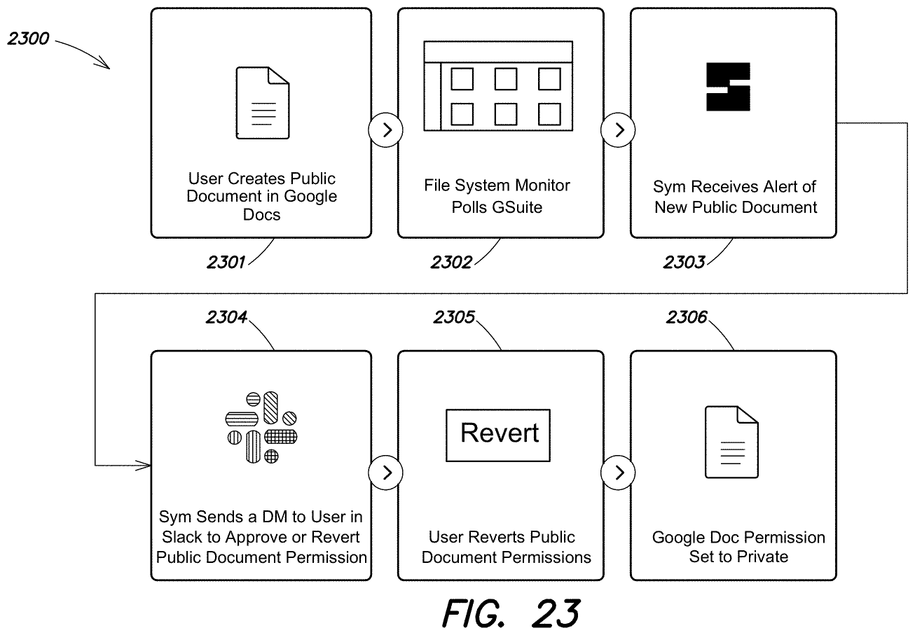

In organizations that keep a lot of their sensitive documents on cloud platforms such as Google Docs, GitHub, or Coda, it is important to have processes in place that can monitor the system to ensure that sensitive information is not made public accidentally. There are a variety of third-party tools on the market (e.g., Splunk, Panther, or other file monitoring/security systems) that can integrate with these document repositories and provide file system monitoring functionalities. FIG. 23 shows an example flow 2300 which shows how the data-leak-prevention template described above can be integrated with the file system monitoring tool to monitor activities in Google Docs.

In flow 2300, the data-leak-prevention template follows the following steps:
Trigger: The Sym platform receives a triggering event from a File System Monitor (e.g., at block 2303), which detects a document on Google Doc is shared publicly (e.g., a user creates a public doc in Google docs at block 2301) and the file system monitor polls GSuite at block 2302.
Sym messages a reviewer (or group of reviewers) that a document has been shared publicly and prompts the reviewer(s) to confirm or reject the action. For example, Sym send a DM to a user in Slack at block 2304 to Approve or Revert public document permission
If confirmed, the flow does nothing; if rejected, the flow escalates to a Lambda instance to call the G-Suite API in order to unshare the document (e.g., by reverting public document permissions at block 2305 and to set the Google doc permissions private at block 2306).
Also, as an option, the steps of the flow and the actions taken by the users/reviewers are logged for future audits.

### Conclusion

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be understood that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be understood that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be understood that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having the same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A system comprising:
a plurality of predefined workflow elements, each of the predefined workflow elements including a configurable template for accessing one or more resource types in a distributed computer system;
providing for a user to selectively implement at least one of the plurality of predefined workflow elements, the at least one workflow element including a configured template, to access at least one resource of a selected resource type; and
a processor configured to instantiate a runtime workflow element based on the configured template.

2. The system according to claim 1, wherein the configured template comprises at least one of a group comprising:
a declaration of a workflow;
resource information identifying the at least one resource; and
logic for accessing the at least one resource.

3. The system according to claim 1, wherein the at least one resource is a computer-based entity, and wherein the processor provides access control functions to the at least one resource.

4. The system according to claim 3, wherein the at least one resource comprises:
a database;
storage;
a service; and
a processing entity.

5. The system according to claim 3, wherein the processor is configured to execute a strategy element associated with the runtime workflow element, the strategy element defining a process for accessing the at least one resource element.

6. The system according to claim 5, wherein the strategy element is a subcomponent of the runtime workflow element.

7. The system according to claim 5, further comprising a target element including information defining the at least one resource element to be accessed.

8. The system according to claim 7, wherein the target element is a subcomponent of the runtime workflow element.

9. The system according to claim 3, wherein the processor is configured to execute a handler element associated with the runtime workflow element, the handler element defining custom logic for executing the runtime workflow element.

10. The system according to claim 9, wherein the handler element includes a reducer element configured to receive an event and return a value.

11. The system according to claim 9, wherein the handler element includes a hook element configured to alter a control flow by overriding a default behavior of the configurable template.

12. The system according to claim 9, wherein the handler element includes an action element configured to subscribe to an event and cause an action to occur responsive to the subscribed event.

13. The system according to claim 1, wherein the system is adapted to define a plurality of user role type for configuring how the processor creates and manages runtime workflow elements, the plurality of user role types comprising:
a regular user type that uses a runtime workflow element to access the at least one resource;
an integrator user type that provides integration elements for accessing a plurality of resources in an organization; and
an implementer user type that is permitted to create and manage runtime workflow elements executed by the system.

14. The system according to claim 1, wherein the configurable template includes an approval template that defines one or more access methods for accessing the at least one resource.

15. The system according to claim 1, further comprising a template interpretation engine configured to interpret a configuration definition.

16. The system according to claim 1, wherein the processor is adapted to receive and process a plurality of events from one or more event sources.

17. The system according to claim 16, wherein the one or more event sources comprise at least one of a group comprising:
a message originated through a messaging platform;
an API;
a command line interface;
a programmatic interface;
a intersystem communication; and
a communication protocol message.

18. The system according to claim 16, wherein the processor further comprises a queuer element configured to receive and queue the plurality of received events.

19. The system according to claim 17, wherein the processor is adapted to process at least one of the plurality of received events from the queue.

20. The system according to claim 19, wherein the processor is adapted to identify, responsive to the at least one of the plurality of received events, a workflow triggered by the event.

21. The system according to claim 20, wherein the processor is further adapted to instantiate a runtime workflow element and execute logic defined within the runtime workflow element.

22. The system according to claim 21, wherein the logic defined within the runtime workflow element includes a handler element.

23. The system according to claim 22, wherein the handler element includes a reducer element configured to receive an event and return a value.

24. The system according to claim 22, wherein the handler element includes a hook element configured to alter a control flow by overriding a default behavior of the configurable template.

25. The system according to claim 22, wherein the handler element includes an action element configured to subscribe to an event and cause an action to occur responsive to the subscribed event.
